(19) United States
(12) Patent Application Publication
(10) Pub. No.: US 2026/0265565 A1
(43) Pub. Date: Sep. 10, 2026

(54) MIXED INK, PRODUCTION METHOD FOR SAME, AND PRODUCTION METHOD FOR SINTERED BODY

(71) Applicants: MITSUI MINING & SMELTING CO., LTD., Tokyo (JP); Kansai University, Osaka (JP)

(72) Inventors: Mitsuhiko NISHINO, Yamaguchi (JP); Hiroki SAWAMOTO, Yamaguchi (JP); Takafumi SAKAKI, Yamaguchi (JP); Rika OOGAMI, Osaka (JP); Hideya KAWASAKI, Osaka (JP)

(21) Appl. No.: 19/166,988

(22) PCT Filed: Mar. 18, 2024
(86) PCT No.: PCT/JP2024/010583

§ 371 Date: Sep. 19, 2025

(30) Foreign Application Priority Data
Mar. 30, 2023 (JP) 2023-056386

(51) Int. Cl. C09D 11/52; B22F 1/05; B22F 1/068; B22F 1/10; B22F 3/10; C09D 11/037

(52) U.S. Cl. CPC C09D 11/52; B22F 1/05; B22F 1/068; B22F 1/10; B22F 3/10; C09D 11/037; B22F 2301/10; B22F 2302/45; B22F 2304/10; B22F 2999/00

(57) ABSTRACT

A mixed ink contains copper microparticles and a nickel formate complex having an ammine ligand or an amino group-containing ligand containing an amino group. The copper microparticles have a volume-based cumulative particle size D50 of 1.5 μm or more and 20.0 μm or less at a cumulative volume of 50 vol %, as measured using a laser diffraction/scattering particle size distribution measurement method, and an aspect ratio of 4.0 or more and 20.0 or less or a BET specific surface area of 0.8 m²/g or more and 4.0 m²/g or less. It is preferable that the copper microparticles have a flat shape. It is also preferable that the amino group-containing ligand is at least one selected from the group consisting of 1-amino-2-propanol, ethylenediamine, and 2-amino-1-butanol.

### CROSS REFERENCE TO RELATED APPLICATIONS

This application is a 371 U.S. National Phase of International Application No. PCT/JP2024/010583, filed on Mar. 18, 2024, which claims priority to Japanese Patent Application No. 2023-056386, filed on Mar. 30, 2023. The entire disclosures of the above applications are incorporated herein by reference.

### BACKGROUND

### Technical Field

The present invention relates to a mixed ink and a method for producing the same. The present invention also relates to a method for producing a sintered body.

### Related Art

Lithography and etching technologies have conventionally been used as methods for producing fine electrical circuit interconnects. These technologies require large-scale sputtering equipment and exposure equipment, and the production process is complicated. Consequently, higher costs are an issue. Therefore, printed electronics technology, which enables the production of electronic circuits on various materials using printing techniques, is garnering attention and being applied in a wide variety of fields.

Conductive inks, for example, are used as materials for forming electrical circuits based on the printed electronics technology. As for the conductive inks, numerous conductive inks using metal microparticles, such as silver particles and copper particles, have been developed.

Among metal microparticles, copper is a highly electrically conductive material, and is therefore useful as a conductive material for establishing electrical continuity between electrodes. For the formation of fine interconnects, reducing the particle size of copper particles is advantageous. However, since copper is a metal that is easily oxidized, copper particles with smaller particle sizes oxidize more easily and are therefore more prone to a reduction in electrical conductivity.

To suppress the oxidation of copper particles, JP 2022-71739A (Patent Literature 1) proposes an ink in which copper particles are combined with a nickel formate complex that has a ligand containing an amino group.

When producing a conductive film by firing a coating film formed using a conductive ink containing copper particles, it is industrially advantageous to perform the firing in an air atmosphere. However, although the technology disclosed in Patent Literature 1 has attempted firing in a nitrogen atmosphere, firing in an air atmosphere, which is an oxidizing atmosphere, has not been examined.

### SUMMARY

Therefore, an object of the present invention is to provide an ink that enables the production of a sintered body with suppressed oxidation, even when firing is performed in an air atmosphere.

To achieve the above-described object, the inventors of the present invention conducted in-depth research and found that it is effective to use copper particles having specific powder properties in combination with a complex having a specific chemical structure.

The present invention was made based on the foregoing findings, and achieves the above-described object by providing a mixed ink comprising:
copper microparticles; and
a nickel formate complex having an ammine ligand or an amino group-containing ligand containing an amino group,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have an aspect ratio of 4.0 or more and 20.0 or less.

The present invention also provides a mixed ink comprising:
copper microparticles; and
a nickel formate complex having an ammine ligand or an amino group-containing ligand,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have a BET specific surface area of 0.8 m²/g or more and 4.0 m²/g or less.

Furthermore, the present invention provides a method for producing a mixed ink, the mixed ink containing
copper microparticles and
a nickel formate complex having an ammine ligand or an amino group-containing ligand containing an amino group,
the method comprising:
preparing a composition by mixing nickel formate, an ammine ligand or an amino group-containing ligand, and a solvent; and
adding copper microparticles to the composition,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have an aspect ratio of 4.0 or more and 20.0 or less.

Furthermore, the present invention provides a method for producing a mixed ink, the mixed ink containing
copper microparticles and
a nickel formate complex having an ammine ligand or an amino group-containing ligand containing an amino group,
the method comprising:
preparing a composition by mixing nickel formate, an ammine ligand or an amino group-containing ligand, and a solvent; and
adding copper microparticles to the composition,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have a BET specific surface area of 0.8 m²/g or more and 4.0 m²/g or less.

### DETAILED DESCRIPTION

A mixed ink of the present invention contains copper microparticles and a nickel formate complex having an ammine ligand or an amino group-containing ligand containing an amino group. The mixed ink of the present invention can be sintered at a relatively low temperature because it contains copper microparticles. In addition, the copper microparticles are stable in the mixed ink.

Copper microparticles are generally more difficult to sinter at low temperatures than, for example, copper nanoparticles. However, the mixed ink of the present invention contains, in addition to copper microparticles, a nickel formate complex having an ammine ligand or an amino group-containing ligand containing an amino group and can therefore be sintered at a relatively low temperature. The reason for this is that, as a nickel source, the nickel formate complex is used rather than nickel metal, which has a higher melting point than copper, and metallic nickel generated as a result of the nickel formate complex being sintered promotes sintering of the copper microparticles.

The nickel formate complex releases hydrogen during its thermal decomposition, and the released hydrogen exhibits a reducing effect, which can suppress oxidation of the copper microparticles. Furthermore, with the mixed ink of the present invention, nickel generated from the nickel formate complex coats the surface of the copper microparticles during the sintering process of the copper microparticles, and thus, high oxidation resistance can be imparted to the resulting sintered body.

As a result of research conducted by the inventors of the present invention, it was found advantageous to use specific copper microparticles in order to enable the production of a sintered body with suppressed oxidation, even when the copper microparticles are fired in an air atmosphere. Specifically, it was found advantageous to use copper microparticles having a particle size and an aspect ratio or a BET specific surface area within specific ranges. Details of such copper microparticles will be described later.

The copper microparticles may be primary particles of copper, or may be copper microparticles in the form of secondary particles formed by aggregation or agglomeration of primary particles of copper.

In order to suppress oxidation of the copper microparticles during firing in an air atmosphere, the volume-based cumulative particle size D50 (hereinafter also referred to simply as “particle size D50”) of the copper microparticles is preferably 1.5 μm or more, more preferably 2.5 μm or more, and even more preferably 4.0 μm or more.

On the other hand, in order to increase the number of contact points between the copper microparticles to increase the contact area between the copper microparticles and thereby enhance the conductivity of the sintered body, the particle size D50 of the copper microparticles is preferably 20.0 μm or less, more preferably 7.0 μm or less, and even more preferably 5.0 μm or less.

Considering the above, the particle size D50 of the copper microparticles is preferably 1.5 μm or more and 20.0 μm or less, more preferably 2.5 μm or more and 7.0 μm or less, and even more preferably 4.0 μm or more and 5.0 μm or less.

In the present specification, the volume-based cumulative particle size D50 refers to the particle size at a cumulative volume of 50 vol % as measured using a laser diffraction/scattering particle size distribution measurement method.

While the value of D50 of the copper microparticles is as described above, the volume-based cumulative particle size D90 (hereinafter also referred to simply as “particle size D90”) of the copper microparticles is preferably 2.5 μm or more, more preferably 3.5 μm or more, and even more preferably 6.0 μm or more. On the other hand, the particle size D90 is preferably 30.0 μm or less, more preferably 20.0 μm or less, even more preferably 15.0 μm or less, and yet even more preferably 10.0 μm or less.

When the value of the particle size D90 of the copper microparticles is within the above-described range, the above-described effects can be achieved more effectively.

Considering the above, the particle size D90 of the copper microparticles is preferably 2.5 μm or more and 30.0 μm or less, more preferably 3.5 μm or more and 20.0 μm or less, even more preferably 3.5 μm or more and 15.0 μm or less, and yet even more preferably 6.0 μm or more and 10.0 μm or less.

In the present specification, the volume-based cumulative particle size D90 refers to the particle size at a cumulative volume of 90 vol % as measured using a laser diffraction/scattering particle size distribution measurement method.

The particle sizes D50 and D90 can be measured using the following method, for example. Specifically, 0.1 g of a measurement sample is mixed with an aqueous dispersant solution and dispersed for one minute using an ultrasonic homogenizer (US-300T manufactured by Nihonseiki Kaisha, Ltd.). After that, a particle size distribution is measured using a laser diffraction/scattering particle size distribution measurement apparatus such as, for example, MT3300 EXII manufactured by MicrotracBEL Corp.

The shape of the copper microparticles may be, for example, spherical, flat, dendritic (tree-like branching shape), or the like. In particular, in order to obtain a sintered body with high conductivity, it is preferable that the copper microparticles have a flat shape. Having a flat shape means that the particles have a thin, plate-like shape. Flat particles can be obtained by, for example, applying a mechanical external force to spherical particles to plastically deform the spherical particles.

When the copper microparticles have a flat shape, their shape in a plan view, that is, the shape of the plate surface, is not particularly limited and may be, for example, substantially circular, substantially oval, substantially elliptical, irregular, or other shapes.

In order to increase the contact area between the copper microparticles and thereby obtain a sintered body with high conductivity, the aspect ratio, expressed as the ratio of the maximum diameter D to the thickness T of the copper microparticles, is preferably 4.0 or more, more preferably 6.1 or more, and even more preferably 12.0 or more.

On the other hand, the aspect ratio of the copper microparticles is usually 20.0 or less, although there is no particular limitation from the viewpoint of achieving the object of the present invention.

Considering the above, the aspect ratio of the copper microparticles is preferably 4.0 or more and 20.0 or less, more preferably 6.1 or more and 20.0 or less, and even more preferably 12.0 or more and 20.0 or less.

To determine the aspect ratio, a cross section of a measurement target particle is observed using an electron microscope, the particle's maximum diameter D (representing the length of the longest straight line connecting two points on the outer perimeter of the particle, and hereinafter also referred to as “particle length D”) and the microparticle's thickness T (hereinafter also referred to as “particle thickness T”) are measured, and the aspect ratio is then calculated by dividing the particle length D by the particle thickness T. The above-described measurement and calculation are performed on 100 or more particles, and the arithmetic mean of the aspect ratios calculated from these particles is used as the aspect ratio in the present invention.

In order to increase the contact area between the copper microparticles and thereby enhance conductivity, the particle length D is preferably 1.0 μm or more, more preferably 2.0 μm or more, and even more preferably 5.0 μm or more.

On the other hand, from the viewpoint of miniaturization of interconnects, the particle length D is preferably 10.0 μm or less, more preferably 8.5 μm or less, and even more preferably 7.0 μm or less.

Considering the above, the particle length D is preferably 1.0 μm or more and 10.0 μm or less, more preferably 2.0 μm or more and 8.5 μm or less, and even more preferably 5.0 μm or more and 8.5 μm or less.

In order to enhance the toughness of the copper particles, the particle thickness T is preferably 0.1 μm or more, more preferably 0.2 μm or more, and even more preferably 0.3 μm or more.

On the other hand, from the viewpoint of miniaturization of interconnects, the particle thickness T is preferably 2.0 μm or less, more preferably 1.5 μm or less, and even more preferably 1.0 μm or less.

Considering the above, the particle thickness T is preferably 0.1 μm or more and 2.0 μm or less, more preferably 0.2 μm or more and 1.5 μm or less, even more preferably 0.3 μm or more and 1.0 μm or less, and yet even more preferably 0.5 μm or more and 0.9 μm or less.

In order to increase the contact area between the copper microparticles and thereby enhance the conductivity of the sintered body, the BET specific surface area of the copper microparticles is preferably 0.6 m²/g or more, more preferably 0.8 m²/g or more, even more preferably 1.5 m²/g or more, yet even more preferably 2.0 m²/g or more, and particularly preferably 2.5 m²/g or more.

On the other hand, the BET specific surface area of the copper microparticles is usually 4.0 m²/g or less, although there is no particular limitation from the viewpoint of achieving the object of the present invention.

Considering the above, the BET specific surface area of the copper microparticles is preferably 0.6 m²/g or more and 4.0 m²/g or less, more preferably 0.8 m²/g or more and 4.0 m²/g or less, even more preferably 1.5 m²/g or more and 4.0 m²/g or less, yet even more preferably 2.0 m²/g or more and 4.0 m²/g or less, and particularly preferably 2.5 m²/g or more and 4.0 m²/g or less.

For example, the BET specific surface area of the copper microparticles can be measured in accordance with a nitrogen adsorption method using, for example, “Macsorb” manufactured by Mountech Co., Ltd. The amount of powder to be measured is 0.2 g, and the pre-degassing conditions are under vacuum at 80° C. for 30 minutes.

The copper microparticle content in the mixed ink is preferably 20 mass % or more, and more preferably 40 mass % or more, relative to the mixed ink being set to 100 mass %.

On the other hand, the copper microparticle content in the mixed ink is preferably 80 mass % or less, more preferably 75 mass % or less, and even more preferably 70 mass % or less, relative to the mixed ink being set to 100 mass %.

Considering the above, the copper microparticle content in the mixed ink is preferably 20 mass % or more and 80 mass % or less, more preferably 40 mass % or more and 75 mass % or less, and even more preferably 40 mass % or more and 70 mass % or less, relative to the mixed ink being set to 100 mass %.

When the lower limit of the copper microparticle content is greater than or equal to the aforementioned value, the volume resistivity of the sintered body formed using the mixed ink is further reduced. On the other hand, when the upper limit of the copper microparticle content is less than or equal to the aforementioned value, the nickel formate complex content is high, and accordingly, the thermal decomposition of the nickel formate complex promotes the sintering of the mixed ink even more, resulting in a further reduction in the volume resistivity of the formed sintered body.

The mixed ink of the present invention contains a nickel formate complex having an ammine ligand or an amino group-containing ligand containing an amino group. The nickel formate complex having an ammine ligand or an amino group-containing ligand (hereinafter also referred to simply as the “nickel formate complex”) can be prepared by, for example, mixing nickel formate, an ammine ligand or an amino group-containing ligand, and a solvent, as in step 1 of a production method, which will be described later.

As the nickel formate, anhydrous nickel formate, nickel formate dihydrate, and the like can be used. Anhydrous nickel formate is preferred from the viewpoint of easier ligand formation. One of nickel formates may be used alone, or two or more nickel formates may be mixed and used.

As the amino group-containing ligand (hereinafter, also referred to simply as “ligand”), any ligand can be used without particular limitation, as long as it contains an amino group and can be used as a ligand. For example, a monodentate or multidentate ligand containing an amino group can be used. Examples of such ligands include 1-amino-2-propanol (IPA), 3-amino-1-propanol (3AP), 2-amino-1-butanol (2AB), ethylenediamine (EDA), diethyltriamine (DETA), triethyltetramine (TETA), tetraethylenepentamine (TEPA), trimethylamine, triethylamine, diisopropylethylamine, propylamine, octylamine, diethylamine, tetramethylethylenediamine, dimethylethylenediamine, 1-aminopentane, 1-aminohexane, hydrazine, and the like. Among these, 1-amino-2-propanol (IPA), 3-amino-1-propanol (3AP), 2-amino-1-butanol (2AB), ethylenediamine (EDA), and 1-aminopentane are preferable because they enable sintering of the mixed ink at an even lower temperature, and 1-amino-2 propanol (IPA), ethylenediamine (EDA), 2-amino-1-butanol (2AB), and 1-aminopentane are more preferable.

It is preferable that the ligand contains a group represented by the formula (1) below. In the formulae (1) to (5) below, * represents a bond.

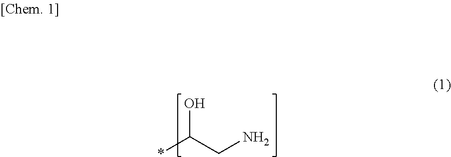

The group represented by the formula (1) is oxidized to a ketone to generate a group represented by the formula (3) below.

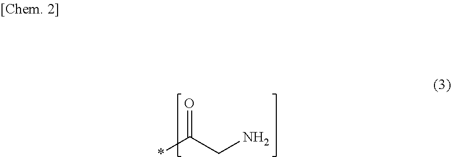

The groups represented by the formulae (1) and (3) above exhibit high coordination power and form a five-membered ring with a nickel atom, thereby becoming groups with a metallacycle structure, respectively represented by the formulae (4) and (5) below, and being stabilized. Due to this, aging of the nickel formate complex in the mixed ink is suppressed.

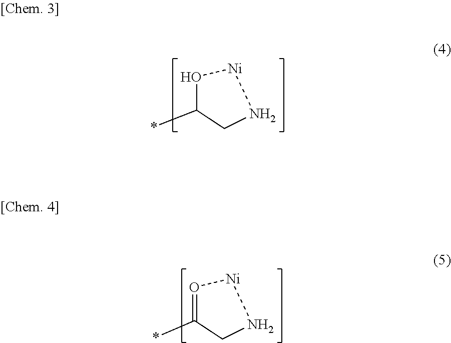

It is also preferable that the ligand contains a group represented by the formula (2) below.

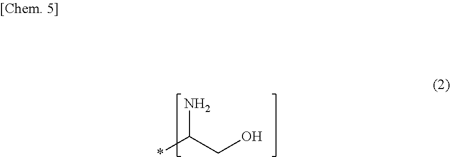

The group represented by the formula (2) above also forms a five-membered ring with a nickel atom, thereby becoming a group with a metallacycle structure and being stabilized. Due to this, aging of the nickel formate complex in the mixed ink is suppressed.

The ligand may also be a compound represented by the formula (6) below.

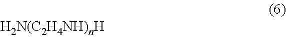

In the formula (6), n represents an integer of 1 or more and 5 or less. Preferably, n is an integer of 1 or more and 3 or less, and more preferably 1.

The ligand may also be a compound represented by the formula (7) below.

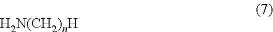

In the formula (7), n represents an integer of 1 or more and 10 or less. Preferably, n is an integer of 3 or more and 8 or less, and more preferably an integer of 5 or more and 8 or less.

The ligand may also be a compound represented by the formula (8) below.

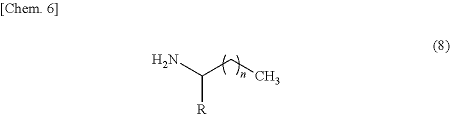

In the formula (8), n represents an integer of 1 or more and 5 or less, and R represents CH₃ or C₂H₅. Preferably, n is an integer of 1 or more and 4 or less, and more preferably an integer of 3 or more and 4 or less.

The ligand may also be a compound represented by the formula (9) below.

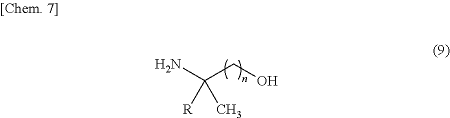

In the formula (9), n represents an integer of 1 or more and 5 or less, and R represents H, CH₃, or C₂H₅. Preferably, n is an integer of 1 or more and 4 or less, and more preferably an integer of 1 or more and 3 or less.

The ligands represented by the formulae (6) to (9) above easily coordinate to a nickel atom, thereby stabilizing. Due to this, aging of the nickel formate complex in the mixed ink is suppressed.

One of the ligands above may be used alone, or two or more thereof may be mixed and used.

When an ammine ligand is used instead of the above-described ligand (amino group-containing ligand), various methods can be employed to prepare a nickel formate complex having an ammine ligand. Note that an ammine ligand is generally also referred to as an ammonia ligand and forms an ammine complex due to the lone pair of electrons in ammonia coordinating to a metal.

Examples of the methods for preparing a nickel formate complex having an ammine ligand include the following methods (a) and (b).
(a) One mole of nickel formate dihydrate and aqueous ammonia are mixed in methanol and stirred at room temperature (25° C.) for 1 hour. The amount of aqueous ammonia added is adjusted so that the amount of ammonia contained in the aqueous ammonia is 2 moles. After filtering out the insoluble material, the resulting methanol solution is concentrated and allowed to stand to prepare a blue precipitate. Then, the precipitate is filtered out and dried under reduced pressure to prepare a nickel formate complex having an ammine ligand.
(b) One mole of nickel (II) oxide and 4 moles of ammonium formate are mixed in methanol and stirred at room temperature (25° C.) for 4 hours. After filtering out the insoluble material, the resulting methanol solution is mixed with ethyl acetate, and the mixture is allowed to stand to prepare a blue precipitate. Then, the precipitate is filtered out and dried under reduced pressure to prepare a nickel formate complex having an ammine ligand.

In the methods (a) and (b) above, methanol is used as an example of the solvent; however, instead of methanol, ethanol, dichloromethane, chloroform, and the like may be used as the solvent.

In addition, it is also possible to prepare an ammine complex salt of nickel by dissolving nickel formate in aqueous ammonia. Furthermore, it is also possible to prepare a nickel formate complex having an ammine ligand by sequentially adding nickel formate, ammonium chloride, and aqueous ammonia.

The nickel formate complex content in the mixed ink is preferably 10 mass % or more, and more preferably 20 mass % or more, relative to the mixed ink being set to 100 mass %.

On the other hand, the nickel formate complex content in the mixed ink is preferably 60 mass % or less, and more preferably 50 mass % or less, relative to the mixed ink being set to 100 mass %.

When the lower limit of the nickel formate complex content is greater than or equal to the aforementioned value, the thermal decomposition of the nickel formate complex promotes the sintering of the mixed ink even more, resulting in a further reduction in the volume resistivity of the formed sintered body. On the other hand, when the upper limit of the nickel formate complex content is less than or equal to the aforementioned value, the ratio of the copper microparticles in the mixed ink is high, resulting in a further reduction in the volume resistivity of the formed sintered body.

In the mixed ink of the present invention, it is preferable to adjust the ratio between the mass M_{Cu} of metallic copper and the mass M_{Ni} of metallic nickel. Specifically, the ratio (hereinafter also referred to as “nickel ratio”) of the mass M_{Ni} of metallic nickel to the sum (M_{Cu}+M_{Ni}) of the mass M_{Cu} of metallic copper and the mass M_{Ni} of metallic nickel is preferably 3 mass % or more, and more preferably 5 mass % or more; preferably 40 mass % or less, more preferably 30 mass % or less, even more preferably 20 mass % or less, and particularly preferably 15 mass % or less; and preferably 3 mass % or more and 40 mass % or less, more preferably 5 mass % or more and 30 mass % or less, even more preferably 5 mass % or more and 20 mass % or less, and yet even more preferably 5 mass % or more and 15 mass % or less.

When the lower limit of the nickel ratio is greater than or equal to the aforementioned value, the thermal decomposition of the nickel formate complex promotes the sintering of the mixed ink even more, resulting in a further reduction in the volume resistivity of the formed sintered body. On the other hand, when the upper limit of the nickel ratio is less than or equal to the aforementioned value, the ratio of the copper microparticles in the mixed ink is high, resulting in a further reduction in the volume resistivity of the formed sintered body.

The mixed ink of the present invention may contain a solvent. For example, when a mixed ink is produced by preparing the above-described nickel formate complex in a solvent to form a composition in step 1 of the production method, which will be described later, and then adding copper microparticles to the composition in step 2, the solvent used in step 1 becomes the solvent contained in the mixed ink as is.

There is no particular limitation on the above solvent. For example, ethers, alcohols, alkyl halides, water, and the like can be used.

There is no particular limitation on the alcohols, and lower monohydric alcohols such as methanol, ethanol, propanol, and butanol; polyols such as ethylene glycol, propylene glycol, and glycerol; and alkyl halides such as dichloromethane and chloroform can be used. Among these, polyols are preferably used due to their reducing properties and low viscosity, and, in particular, ethylene glycol and propylene glycol are preferable, and ethylene glycol is more preferable. One of solvents may be used alone, or two or more solvents may be mixed and used.

A method for producing the mixed ink of the present invention includes the following steps 1 and 2.
(1) Step 1 of mixing nickel formate, an amine ligand or an amino group-containing ligand, and a solvent to prepare a composition.
(2) Step 2 of adding copper microparticles to the composition.

Steps 1 and 2 are carried out in this order.

As for the nickel formate, the ammine ligand or the amino group-containing ligand, and the solvent used in step 1, the same nickel formate, ammine ligand, amino group-containing ligand, and solvent as those described above for the mixed ink can be used. Therefore, detailed descriptions are not provided here.

The nickel formate content in the composition is preferably 5 mass % or more, and more preferably 10 mass % or more, relative to the composition being set to 100 mass %.

On the other hand, the nickel formate content in the composition is preferably 50 mass % or less, and more preferably 30 mass % or less, relative to the composition being set to 100 mass %.

When the lower limit of the nickel formate content is greater than or equal to the aforementioned value, a nickel formate complex can be sufficiently formed in the composition.

The content of the ammine ligand or the amino group-containing ligand in the composition is preferably 8 molar equivalents or less, and more preferably 6 molar equivalents or less, relative to the nickel formate content in the composition being set to 1 molar equivalent.

On the other hand, the content of the ammine ligand or the amino group-containing ligand in the composition is preferably 2 molar equivalents or more, and more preferably 4 molar equivalents or more, relative to the nickel formate content in the composition being set to 1 molar equivalent.

When the lower limit of the content of the ammine ligand or the amino group-containing ligand is greater than or equal to the aforementioned value, the nickel formate complex can be sufficiently formed in the composition. On the other hand, when the upper limit of the content of the ammine ligand or the amino group-containing ligand is less than or equal to the aforementioned value, complex formation is further facilitated.

The solvent content in the composition is preferably 10 mass % or more, and more preferably 30 mass % or more, relative to the composition being set to 100 mass %.

On the other hand, the solvent content in the composition is preferably 80 mass % or less, and more preferably 60 mass % or less, relative to the composition being set to 100 mass %.

When the lower limit of the solvent content is greater than or equal to the aforementioned value, the nickel formate and the ligand can be sufficiently dispersed in the composition, and accordingly, the nickel formate complex can be sufficiently formed. On the other hand, when the upper limit of the solvent content is less than or equal to the aforementioned value, the nickel formate complex content in the composition is even more sufficient, and accordingly, the nickel formate complex can be sufficiently formed.

In step 1, there is no particular limitation on the temperature of the composition during the mixing of the components. For example, this temperature can be set to approximately 0° C. or higher and 40° C. or lower.

In step 1, the composition may be stirred during the mixing of the components. The stirring time is not particularly limited. For example, the stirring time can be set to approximately 30 minutes or longer and 60 minutes or shorter.

Step 1 may include a nickel formate anhydrate preparation step of preparing nickel formate anhydrate by heating nickel formate hydrate. When step 1 includes the nickel formate anhydrate preparation step, the nickel formate complex can be prepared even more efficiently.

An example of a method for preparing nickel formate anhydrate is to heat nickel formate hydrate, such as nickel formate dihydrate mentioned above.

There is no particular limitation on the heating temperature in the nickel formate anhydrate preparation step. For example, the heating temperature can be set to approximately 170° C. or higher and 230° C. or lower. The heating time can be set to, for example, approximately 30 minutes or longer and 120 minutes or shorter.

As a result of step 1 described above, a composition containing a nickel formate complex having an ammine ligand or an amino group-containing ligand is prepared.

Step 2 is a step of adding copper microparticles to the composition. As the copper microparticles used in step 2, the same copper microparticles as those described above for the mixed ink can be used. For example, copper microparticles with a particle size D50 of 1.5 μm or more and 20.0 μm or less and an aspect ratio of 4.0 or more and 20.0 or less can be used. Alternatively, copper microparticles with a particle size D50 of 1.5 μm or more and 20.0 μm or less and a BET specific surface area of 0.8 m²/g or more and 4.0 m²/g or less can also be used.

The amount of copper microparticles added in step 2 is preferably 20 mass % or more, and more preferably 40 mass % or more, relative to the composition being set to 100 mass %.

On the other hand, the amount of copper microparticles added is preferably 80 mass % or less, and more preferably 60 mass % or less, relative to the composition being set to 100 mass %. When the lower limit of the amount of copper microparticles added is greater than or equal to the aforementioned value, the volume resistivity of the sintered body formed using the produced mixed ink is further reduced. On the other hand, when the upper limit of the amount of copper microparticles added is less than or equal to the aforementioned value, the nickel formate complex content in the mixed ink is high, and accordingly, the thermal decomposition of the nickel formate complex promotes the sintering of the mixed ink even more, resulting in a further reduction in the volume resistivity of the formed sintered body.

In step 2, there is no particular limitation on the temperature of the composition during the addition of the copper microparticles. For example, this temperature can be set to approximately 0° C. or higher and 40° C. or lower.

In step 2, the composition may be stirred during the addition of the copper microparticles. The stirring time is not particularly limited. For example, the stirring time can be set to approximately 0.5 minutes or longer and 10 minutes or shorter.

Step 2 may include an oxide film removal step of removing an oxide film present on the surface of the copper microparticles before adding the copper microparticles to the composition.

There is no particular limitation on the method for removing the oxide film. For example, a method in which the copper microparticles are immersed in a reducing agent may be used.

There is no particular limitation on the reducing agent. Examples include formic acid, hydrazine compounds, and the like. Among these, formic acid is preferred due to its superior reducing properties.

The immersion time for which the copper microparticles are immersed in the reducing agent is not particularly limited. For example, the immersion time can be set to approximately 30 minutes or longer and 120 minutes or shorter.

In step 2, preferably, the copper microparticles are added so as to provide a nickel ratio of 3 mass % or more and 40 mass % or less; more preferably, the copper microparticles are added so as to provide a nickel ratio of 5 mass % or more and 30 mass % or less; even more preferably, the copper microparticles are added so as to provide a nickel ratio of 5 mass % or more and 20 mass % or less; and particularly preferably, the copper microparticles are added so as to provide a nickel ratio of 5 mass % or more and 15 mass % or less.

When the lower limit of the nickel ratio is greater than or equal to the aforementioned value, the thermal decomposition of the nickel formate complex promotes the sintering of the produced mixed ink even more, resulting in a further reduction in the volume resistivity of the formed sintered body. On the other hand, when the nickel ratio is less than or equal to the aforementioned value, the ratio of the copper microparticles in the produced mixed ink is high, resulting in a further reduction in the volume resistivity of the formed sintered body.

As a result of step 2 described above, the copper microparticles are added to the composition prepared in step 1, and thus, a mixed ink of the present invention is produced.

Since the mixed ink of the present invention contains the specific copper microparticles and the nickel formate complex having an ammine ligand or an amino group-containing ligand, the mixed ink enables the formation of fine copper interconnects with suppressed oxidation in a short period of time, or enables two bonding target objects to be bonded to each other, even when firing is performed in an air atmosphere at temperatures within a low temperature range of 200° C. or lower. A method for producing a sintered body by firing this mixed ink in an air atmosphere at a temperature of 200° C. or lower is also an aspect of the present invention. The firing temperature is preferably 190° C. or lower, and more preferably 180° C. or lower. On the other hand, the firing temperature is preferably 70° C. or higher, more preferably 80° C. or higher, and even more preferably 90° C. or higher. In this case, the firing can be performed under normal pressure. Specifically, the formation of fine copper interconnects can be performed under normal pressure (1 atm). Alternatively, two bonding target objects can be bonded to each other under no load (i.e., only the weight of the bonding target objects).

In addition, when firing the mixed ink in an inert atmosphere, the firing temperature is preferably 200° C. or lower, and more preferably 180° C. or lower. On the other hand, the firing temperature is preferably 70° C. or higher, and more preferably 80° C. or higher.

When firing the mixed ink in an inert atmosphere (for example, in a nitrogen or argon atmosphere), the firing may be performed under normal pressure or reduced pressure. The pressure during firing under reduced pressure is not particularly limited and can be any pressure lower than normal pressure.

The mixed ink of the present invention can be suitably used as an ink material for forming fine metal interconnects and a bonding material for power semiconductor applications. However, the mixed ink of the present invention is not limited to these applications and can also be used in other applications, for example, as a catalyst material (a catalyst or a catalyst carrier). Furthermore, the mixed ink of the present invention can also be used as a transparent conductive film in place of ITO, and as an anti-reflective coating material.

Regarding the embodiments described above, a mixed ink and a method for producing the same as well as a method for producing a sintered body are further disclosed below.
[1] A mixed ink comprising:
   copper microparticles; and
   a nickel formate complex having an ammine ligand or an amino group-containing ligand containing an amino group,
   wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
   the copper microparticles have an aspect ratio of 4.0 or more and 20.0 or less.
[2] A mixed ink comprising:
   copper microparticles; and
   a nickel formate complex having an ammine ligand or an amino group-containing ligand,
   wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
   the copper microparticles have a BET specific surface area of 0.8 m²/g or more and 4.0 m²/g or less.
[3] The mixed ink as set forth in clause [1] or [2], wherein the copper microparticles have a volume-based cumulative particle size D90 of 2.5 μm or more and 30.0 μm or less at a cumulative volume of 90 vol %, as measured using a laser diffraction/scattering particle size distribution measurement method.
[4] The mixed ink as set forth in any one of clauses [1] to [3], wherein the copper microparticles have a flat shape.
[5] The mixed ink as set forth in any one of clauses [1] to [4], wherein the amino group-containing ligand contains a group represented by a formula (1) or (2) below:

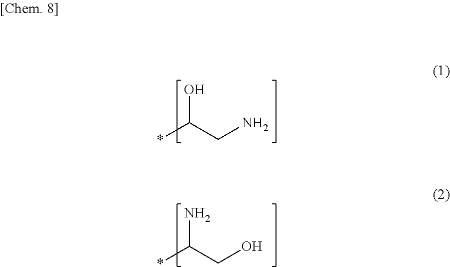

wherein, in the formulae (1) and (2), * represents a bond.
[6] The mixed ink as set forth in any one of clauses [1] to [5], wherein the amino group-containing ligand is represented by a formula (6) below:

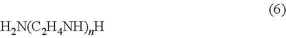

wherein, in the formula (6), n represents an integer of 1 or more and 5 or less.
[7] The mixed ink as set forth in any one of clauses [1] to [6], wherein the amino group-containing ligand is represented by a formula (7) below:

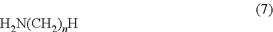

wherein, in the formula (7), n represents an integer of 1 or more and 10 or less.
[8] The mixed ink as set forth in any one of clauses [1] to [7], wherein the amino group-containing ligand is represented by a formula (8) below:

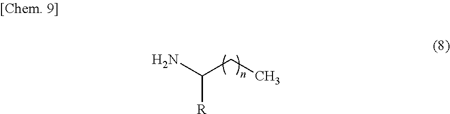

wherein, in the formula (8), n represents an integer of 1 or more and 5 or less, and R represents CH₃ or C₂H₅.
[9] The mixed ink as set forth in any one of clauses [1] to [8], wherein the amino group-containing ligand is represented by a formula (9) below:

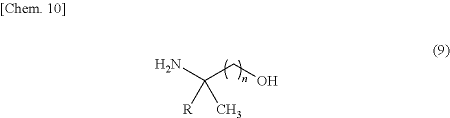

wherein, in the formula (9), n represents an integer of 1 or more and 5 or less, and R represents H, CH₃, or C₂H₅.
[10] The mixed ink as set forth in any one of clauses [1] to [9], wherein the amino group-containing ligand is at least one selected from the group consisting of 1-amino-2-propanol, ethylenediamine, and 2-amino-1-butanol.
[11] The mixed ink as set forth in any one of clauses [1] to [10], wherein a ratio of a mass M_{Ni} of metallic nickel to a sum of a mass M_{Cu} of metallic copper and the mass M_{Ni} of the metallic nickel is 3 mass % or more and 40 mass % or less.
[12] A method for producing a sintered body, comprising:
   sintering the mixed ink as set forth in any one of clauses [1] to [11] at a temperature of 200° C. or lower to obtain a sintered body.
[13] A method for producing a mixed ink, the mixed ink containing
   copper microparticles and
   a nickel formate complex having an ammine ligand or an amino group-containing ligand containing an amino group,
   the method comprising:
   preparing a composition by mixing nickel formate, an ammine ligand or an amino group-containing ligand, and a solvent; and
   adding copper microparticles to the composition,
   wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
   the copper microparticles have an aspect ratio of 4.0 or more and 20.0 or less.
[14] A method for producing a mixed ink, the mixed ink containing
   copper microparticles and
   a nickel formate complex having an ammine ligand or an amino group-containing ligand containing an amino group,
   the method comprising:
   preparing a composition by mixing nickel formate, an ammine ligand or an amino group-containing ligand, and a solvent; and
   adding copper microparticles to the composition,
   wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
   the copper microparticles have a BET specific surface area of 0.8 m²/g or more and 4.0 m²/g or less.

### EXAMPLES

Hereinafter, the present invention will be described in further detail with reference to examples and comparative examples. However, the present invention is not limited to the examples provided below.

### Example 1

### (1) Preparation of Amine-Nickel Formate Complex

Nickel formate dihydrate was heated at 200° C. for 1 hour to obtain nickel formate anhydrate. To 2 g of the obtained nickel formate anhydrate, 4 molar equivalents of 1-amino-2-propanol (IPA) (4.15 mL) and 8 mL of methanol were added and mixed, and the mixture was stirred at normal temperature for 1 hour to prepare an amine-nickel formate complex.

### (2) Preparation of Copper Microparticles

1.4 g of flat copper microparticles were added to 20 mL of formic acid and immersed therein for 1 hour to remove an oxide film from the surface of the copper microparticles. Then, the copper microparticles were washed with 30 mL of ethanol four times. The washed copper microparticles were dried in a N₂ atmosphere. The particle size D50, particle size D90, particle length D, particle thickness T, aspect ratio, and BET specific surface area of the resulting copper microparticles are shown in Table 1.

### (3) Preparation of Mixed Ink

Ethylene glycol was provided as a solvent. The copper microparticles and the amine-nickel formate complex were mixed in ethylene glycol and then stirred using a mixer (product name: Awatori Rentaro, manufactured by Thinky Corporation) to prepare a mixed ink. The mixing ratio of the copper microparticles and the amine-nickel formate complex was adjusted to obtain the nickel ratio value shown in Table 1. The mixed ink was prepared in this manner

### Examples 2 to 5 and Comparative Examples 1 to 4

A mixed ink was obtained in the same manner as in Example 1, except that copper microparticles having the particle size D50, particle size D90, particle length D, particle thickness T, aspect ratio, and BET specific surface area shown in Table 1 were used.

### Evaluation

The mixed inks obtained in the examples and the comparative examples were each applied onto a polyimide substrate using a doctor blade (12 μm) to obtain a coating film. This coating film was heated under the conditions in an air atmosphere at a temperature of 180° C. for 10 min to obtain a sintered body. The volume resistivity (Ω·cm) of the obtained sintered body was measured using a four point probe method. The measurement was performed using a Loresta-EP resistivity meter (Loresta-EP MCP-T360) and a four point probe (MCP-TPQPP). The film thickness of the sintered body was measured using a micrometer, and the volume resistivity (22 cm) was calculated by multiplying the film thickness by the resistance value. Table 1 shows the results. Note that “OL” in Table 1 indicates a volume resistivity that is greater than or equal to the measurement limit of 9.9×10⁶ Ω·cm.

TABLE 1

| | Copper microparticles | | | | | | | Mixed ink | | Sintered |
|---|---|---|---|---|---|---|---|---|---|---|
| | | Particle | Particle | Particle | Particle | | | Copper | Nickel | body |
| | | size | size | length | thickness | Aspect | BET specific | microparticle | ratio | Volume |
| | | D50 | D90 | D | T | ratio | surface area | content | [%] M_{Ni}/ | resistivity |
| | Shape | [μm] | [μm] | [μm] | [μm] | D/T | [m²/g] | [%] | (M_{Cu} + M_{Ni}) | [Ω · cm] |
| Ex. 1 | Flat | [symbol] .0 | 0.30 | 1.8 | 3.1 | 1.9 | 2.2 | 70.0 | 5.0 | 7.0 × 10⁻⁴ |
| Ex. 2 | Flat | [symbol] .4 | 0.19 | 1.8 | 3.9 | 2.1 | 2.5 | 70.0 | 5.0 | 5.0 × 10⁻⁴ |
| Ex. 3 | Flat | [symbol] .9 | 0.80 | 5.5 | 8.2 | 4.8 | 1.9 | 70.0 | 5.0 | 5.0 × 10⁻⁵ |
| Ex. 4 | Flat | 6.2 | 1.09 | 6.8 | 10.6 | 6.6 | 0.8 | 70.0 | 5.0 | 1.0 × 10⁻⁴ |
| Ex. 5 | Flat | 13.1 | 0.62 | 8.1 | 11.9 | 6.7 | | | 5.0 | 5.0 × 10⁻⁵ |
| Com. | Flat | 6.1 | 0.18 | 1.1 | 1.5 | 1.0 | 2.0 | 70.0 | 5.0 | 7.0 × 10⁻³ |
| Ex. 1 | | | | | | | | | | |
| Com. | Flat | 3.1 | 0.77 | 2.4 | 4.0 | 2.4 | 0.4 | 70.0 | 5.0 | 8.0 × 10⁻³ |
| Ex. 2 | | | | | | | | | | |
| Com. | Spherical | 1.0 | — | 3.5 | [symbol] | [symbol] | 0.3 | 70.0 | 5.0 | OL |
| Ex. 3 | | | | | | | | | | |
| Com. | Flat | 3.3 | 1.79 | 5.9 | 12.3 | 6.2 | 0.4 | 70.0 | 5.0 | 7.0 × 10⁻¹ |
| Ex. 4 | | | | | | | | | | |

[symbol]

indicates data missing or illegible when filed

As is clear from the results shown in Table 1, it can be seen that the sintered bodies obtained in the examples had low volume resistivity, even though these sintered bodies were formed through firing in an air atmosphere. In particular, it can be seen that the sintered bodies obtained in Examples 3 to 5 had even lower volume resistivity.

### INDUSTRIAL APPLICABILITY

According to the present invention, a mixed ink is provided that enables the production of a sintered body with suppressed oxidation, even when firing is performed in an air atmosphere.

1-14. (canceled)

15. A mixed ink comprising:
copper microparticles; and
a nickel formate complex having an ammine ligand or an amino group-containing ligand containing an amino group,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have an aspect ratio of 4.0 or more and 20.0 or less.

16. A mixed ink comprising:
copper microparticles; and
a nickel formate complex having an ammine ligand or an amino group-containing ligand,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have a BET specific surface area of 0.8 m²/g or more and 4.0 m²/g or less.

17. The mixed ink according to claim 15, wherein the copper microparticles have a volume-based cumulative particle size D90 of 2.5 μm or more and 30.0 μm or less at a cumulative volume of 90 vol %, as measured using a laser diffraction/scattering particle size distribution measurement method.

18. The mixed ink according to claim 15, wherein the copper microparticles have a flat shape.

19. The mixed ink according to claim 15, wherein the amino group-containing ligand contains a group represented by a formula (1) or (2) below: 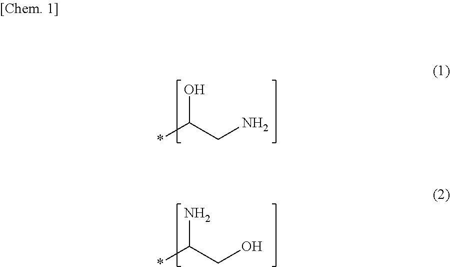
wherein, in the formulae (1) and (2), * represents a bond.

20. The mixed ink according to claim 15, wherein the amino group-containing ligand is represented by a formula (6) below: 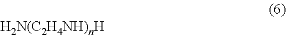
wherein, in the formula (6), n represents an integer of 1 or more and 5 or less.

21. The mixed ink according to claim 15, wherein the amino group-containing ligand is represented by a formula (7) below: 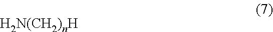
wherein, in the formula (7), n represents an integer of 1 or more and 10 or less.

22. The mixed ink according to claim 15, wherein the amino group-containing ligand is represented by a formula (8) below: 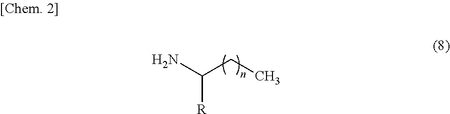
wherein, in the formula (8), n represents an integer of 1 or more and 5 or less, and R represents CH₃ or C₂H₅.

23. The mixed ink according to claim 15, wherein the amino group-containing ligand is represented by a formula (9) below: 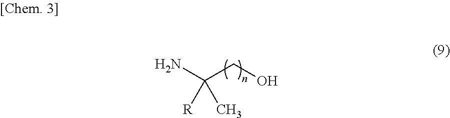
wherein, in the formula (9), n represents an integer of 1 or more and 5 or less, and R represents H, CH₃, or C₂H₅.

24. The mixed ink according to claim 15, wherein the amino group-containing ligand comprises at least one selected from the group consisting of 1-amino-2-propanol, ethylenediamine, and 2-amino-1-butanol.

25. The mixed ink according to claim 15, wherein a ratio of a mass M_{Ni} of metallic nickel to a sum of a mass M_{Cu} of metallic copper and the mass M_{Ni} of the metallic nickel is 3 mass % or more and 40 mass % or less.

26. A method for producing a sintered body, comprising:
sintering the mixed ink according to claim 15 at a temperature of 200° C. or lower to obtain a sintered body.

27. A method for producing a mixed ink, the mixed ink containing
copper microparticles and
a nickel formate complex having an ammine ligand or an amino group-containing ligand containing an amino group,
the method comprising:
preparing a composition by mixing nickel formate, an ammine ligand or an amino group-containing ligand, and a solvent; and
adding copper microparticles to the composition,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have an aspect ratio of 4.0 or more and 20.0 or less.

28. A method for producing a mixed ink, the mixed ink containing
copper microparticles and
a nickel formate complex having an ammine ligand or an amino group-containing ligand containing an amino group,
the method comprising:
preparing a composition by mixing nickel formate, an ammine ligand or an amino group-containing ligand, and a solvent; and
adding copper microparticles to the composition,
wherein the copper microparticles have a volume-based cumulative particle size D50 of 1.5 μm or more and 20.0 μm or less at a cumulative volume of 50 vol %, as measured using a laser diffraction/scattering particle size distribution measurement method, and
the copper microparticles have a BET specific surface area of 0.8 m²/g or more and 4.0 m²/g or less.
